(19) United States
(12) Patent Application Publication
(10) Pub. No.: US 2017/0222598 A1
(43) Pub. Date: Aug. 3, 2017

(54) PORTABLE MODULAR SHELTER APPARATUS

(71) Applicant: BLUE PLANET BUILDINGS (UK) LIMITED

(72) Inventor: Stephen Campbell, Nottingham (GB)

(21) Appl. No.: 15/513,338

(22) PCT Filed: Sep. 22, 2015
(86) PCT No.: PCT/GB2015/052734

§ 371 Date: Mar. 22, 2017

(30) Foreign Application Priority Data
Sep. 23, 2014 (GB) GB 1416783.7

(51) Int. Cl. H02S 10/40; H02S 10/12; E04H 1/12; E04H 5/04; E04B 1/343; E04H 1/00

(52) U.S. Cl. CPC H02S 10/40; E04B 1/34321; E04B 1/34336; E04B 1/34384; E04H 1/005; E04H 1/1205; E04H 5/04; H02S 10/12; E04H 2001/1283

(57) ABSTRACT

A portable modular shelter apparatus comprises a base, a roof, a plurality of wall elements, a plurality of corner elements, a photovoltaic solar collector, electrical circuit componentry and a utility panel. The base defines a storage compartment. The apparatus is configurable from a disassembled transport condition into an assembled condition, in which the base, roof, walls and corners are configured to releasably interlock to form a rigid shelter having a solar powered electricity supply circuit.

### FIELD OF THE INVENTION

The present invention relates to portable modular shelter apparatus, configurable between a disassembled transport condition and an assembled condition.

### BACKGROUND OF THE INVENTION

It is known for modular buildings to be provided on a non-permanent basis at locations such as construction sites, and at events such as festivals and concerts. It is also known for modular structures to be provided for personnel working in remote locations such as forests and mountainous areas, where transportation of building materials is difficult and a local power grid may not be available. Further, aid agencies or the military may require modular structures which can be easily and quickly deployed in locations affected by natural disasters, such as earthquakes or flooding, for use as living accommodation or as medical treatment centres.

In International Patent Application No. WO2010089535 the present applicant discloses a re-usable modular shelter which can be easily transported and assembled, and which comprises an integral solar-powered electricity supply. The portable modular shelter is capable of providing weatherproof living accommodation, can be assembled with no specialist tools and disassembled for further use elsewhere.

Problems arise, however, where a modular building (such as the one described above) must be assembled by non-specialist personnel, who may have no construction experience at all. In such a situation, components of the modular building may not be installed correctly, or may be lost or damaged during installation. The modular building may then not function as well, or be as secure, as expected and damaged or lost parts may need to be replaced. Similar problems may arise when the building is disassembled in order to be re-used elsewhere.

A further problem with existing modular building design is the storage and transport of the components required for assembly of the modular building.

It is well known for the basic components of a portable modular building to be designed so as to fit within the dimensions of a standard shipping container. However, it is often the case that additional or optional components will not fit within the disassembled footprint of the building when it is in its disassembled, transport condition. In such cases, these additional or optional components must be transported separately, taking up more space than is desirable.

It is hence an object of the present invention to provide an alternative portable and modular shelter which overcomes the above problems, which provides a means of simplifying the construction of the building and which allows for more efficient transportation of the building's components.

### SUMMARY OF THE INVENTION

According to a first aspect of the present invention, there is provided portable modular shelter apparatus, comprising: a base; a roof; a plurality of wall elements; a plurality of corner elements; a photovoltaic solar collector; electrical circuit componentry; a utility panel; said base element defining a storage compartment; said apparatus configurable from a disassembled transport condition into an assembled condition, in which said base element, roof element, wall elements and corner elements are configured to releasably interlock to form a rigid shelter comprising a solar powered electricity supply circuit.

Advantageously the shelter can be easily and quickly deployed; may be self-powered and provides storage for components which may otherwise have to be transported separately.

The terms apparatus and shelter are used interchangeably throughout.

In one embodiment, the base, roof, wall elements and corner elements interlock mechanically when in said assembled condition.

In one embodiment the interlock mechanism is a simple mechanism.

Advantageously the mechanical connection produces a rigid, secure shelter which is easy to assemble even by unskilled personnel, without the requirement for specialist tools.

In one embodiment, the base, roof, wall elements and corner elements may each independently further comprise an integral weather seal.

Advantageously an integral weather seal does not need to be separately installed during assembly of the shelter and therefore cannot be incorrectly fitted by unskilled or inexperienced personnel. The weather resistant nature of the shelter is therefore ensured.

In one embodiment, the base, roof, wall elements and corner elements each independently comprise a thermal break to prevent heat transfer between an interior and an exterior of said rigid shelter.

The thermal break beneficially ensures that heat is not lost from the interior to the exterior of the shelter in cold climates or weather, and conversely that the shelter remains cool in hot climates or weather.

In one embodiment, when the shelter is in the assembled condition, an outer face of at least one of the plurality of wall elements or the roof comprises photovoltaic material.

The photovoltaic material beneficially collects solar energy in order to power the assembled shelter. Integral solar panels do not require separate installation and are therefore at less risk of damage or incorrect installation.

In one embodiment the shelter comprises integral solar panels.

In one embodiment, the portable modular shelter apparatus further comprises an electricity storage device.

The electricity storage device beneficially allows storage of solar electricity produced by the solar collectors, or by other sources of electricity. An energy source is therefore available when solar power is not directly available, for example, at night or during a power cut.

In one embodiment the energy storage device is a battery or batteries.

In one embodiment, the storage compartment is suitable for housing batteries, both in said disassembled transport condition and in the assembled condition.

Advantageously, the storage compartment being suitable for storage of batteries means that the batteries do not need to be transported separately, therefore less space is utilised. Additionally, one or more batteries may be transported within the storage compartment in a partially or fully charged condition. Such batteries are therefore available to provide power for the assembly of the rigid shelter. Storage and transport of batteries is particularly difficult because certain types of battery may discharge noxious gas or be prone to thermal runaway, thereby presented a health or fire risk. The present invention overcomes these difficulties by providing a safe transportation environment.

In one embodiment the batteries are stored in the storage compartment.

In one embodiment, the batteries are suitable for storing electricity.

In one embodiment the batteries are suitable for supplying electricity to the shelter.

Beneficially, the batteries can store electricity, for example from the solar panels, and supply electricity to the shelter as required.

Batteries as employed herein may be rechargeable batteries, such as lithium-ion batteries, for example, lithium ferrous phosphate batteries.

Other types of rechargeable or non-rechargeable batteries may be used, for example, lead-acid batteries, nickel cadmium batteries, nickel metal hydride batteries.

In one embodiment the battery or batteries are lithium ferrous phosphate batteries.

Batteries which are unsuitable for storage within the storage compartment, because they may present a health or fire risk, may be housed in a separate structure.

In one embodiment the shelter is provided with a generator.

In one embodiment, the base houses at least one of: electrical circuit componentry; jointing elements; air conditioning.

Advantageously, locating such components within the base provides more space in the interior of the rigid shelter and prevents damage to these components, during assembly and during use of the shelter.

In one embodiment, the portable modular shelter apparatus further comprises plumbing circuit componentry.

Alternatively, in one embodiment, the modular shelter apparatus does not include plumbing circuit componentry. In such an embodiment, the plumbing circuit componentry is supplied and installed separately, as required.

In one embodiment, the portable modular shelter apparatus further comprises a utility panel.

In one embodiment the utility panel is housed within a wall panel.

In one embodiment, the utility panel independently comprises at least one of: a power supply type control device, a power input type indicator, a power output type indicator, operating voltage indicator, a power input gauge, a power output gauge, a stored power gauge, an electric plug socket, a switch, a water supply control device, a water input gauge, a water output gauge, a stored water gauge, a gas flow control device, a gas input gauge, a gas output gauge, a diagnostics device, a power supply register device, a power supply termination device, a battery charging device, a solar photovoltaic inverter.

In one embodiment, the portable modular shelter apparatus further comprises a battery power inverter charger.

In one embodiment, the portable modular shelter apparatus comprises a plurality of adjustable support devices.

In one embodiment the adjustable support devices are releasably connected to the base.

In one embodiment, the portable modular shelter apparatus is dimensioned to allow one to five of said apparatus in the disassembled storage condition to be stored within a standard twenty foot by eight foot shipping container, such as two, three or four apparatus, for example, three apparatus.

In one embodiment, said utility panel is directly or indirectly connected to an engine-generator, and when connected, is configurable to initiate or terminate the supply of electricity from said engine-generator in response to detection of a pre-determined condition, such as a specific ration of electricity being used.

In one embodiment, the utility panel is directly or indirectly connected an alternate external energy source, including but not limited to such as a wind turbine, a mains power grid, a hydroelectric power source, a wave energy generator, a biomass generator, a geothermal energy source.

In one embodiment the alternate external energy source is selected from a wind turbine, a mains power grid.

In one embodiment, the utility panel is configurable to supply electricity at different voltages and frequencies.

Advantageously this permits the shelter to be used in countries using difference voltage and frequency without the need to change the electrical circuitry, for example Europe and the USA.

In one embodiment the portable modular shelter apparatus comprises at least one internal partition element. Beneficially, internal partition elements permit the internal layout of the shelter to be modified according to specific use, for example, the provision of bedrooms or office space.

In one embodiment, the plurality of wall elements comprises at least one wall element providing a door.

In one embodiment, the plurality of wall elements comprises at least wall element providing a window.

In one embodiment, the roof consists of a single panel roof.

In one embodiment, the roof comprises a welded roof/gutter frame.

In one embodiment, an internal surface of the roof defines recesses suitable for housing lighting strips.

In one embodiment a jointing kit is used to connect one shelter with one or more further shelters.

In one embodiment, at least two of said shelters are connected in the assembled condition to form a plurality of connected shelters.

Advantageously, connecting two or more shelters enables the dimensions and layout of the assembled shelter to be configured to each situation and use.

In one embodiment two or more shelters are connected by means of a flexible gasket.

In one embodiment the flexible gasket is stored in the base in the disassembled transport condition.

In one embodiment two or more shelters are connected using the existing wall panels and the addition of a canopy roof.

In one embodiment, the portable modular shelter apparatus comprises a storey element to provide a rigid shelter with an additional storey. Typically stairs or steps are provided where a storey element is used.

In one embodiment, the portable modular shelter apparatus is configurable from an assembled condition into a disassembled transport condition.

In one embodiment the storage compartment is in the base.

According to a second aspect, there is provided a method of providing a rigid shelter comprising a solar powered electricity supply circuit, comprising the steps of: receiving apparatus according to the disclosure in the disassembled transport condition; configuring said apparatus into an assembled condition providing a rigid shelter comprising a solar powered electricity supply circuit according to the disclosure.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a perspective view of a standard shipping container containing three portable modular shelter apparatus in the dissembled transport condition, according to the present invention;

FIG. 2 is a perspective view of the apparatus of FIG. 1, removed from the container;

FIG. 3 is a perspective view of the apparatus of FIG. 1, in which the bases have been moved into position;

FIG. 4 is a perspective view of the apparatus of FIG. 1, in which the walls have been interlocked with the base;

FIG. 5 is a perspective view of the apparatus of FIG. 1, in the assembled condition;

FIG. 6a is a perspective view of the apparatus of FIG. 1, the front section cut away to show the interior;

FIG. 6b is a perspective view of the apparatus of FIG. 1, further comprising a battery power inverter charger;

FIG. 7 is a schematic diagram showing the power management system of the present invention;

FIG. 7A is a schematic diagram showing the power management system in more detail than shown in FIG. 7;

FIG. 8 is a further schematic diagram showing the power management system of the apparatus according to the present invention;

FIG. 9 is a perspective view of four of the portable modular shelter apparatus, linked together to form a plurality of rigid shelters;

FIG. 10 is a perspective view of two wall panels, according to the present invention;

FIG. 11 is a perspective view of a corner panel or element, according to the present invention;

FIG. 12 is a perspective view of the corner panel or element of FIG. 11;

FIG. 13 is a perspective view of two rigid shelters, according to the present invention, close-coupled together.

FIGS. 13A-E are perspective views of the sequence of changing two rigid shelters into three rigid shelters according to the present invention, close-coupled together.

FIG. 14a is a perspective view of an interior of a wall panel configured to house a utility panel, according to the present invention; and

FIG. 14b is a perspective view of an exterior of a wall panel configured to house a utility panel, according to the present invention.

FIGS. 15A-C are perspective views of the sequence of safely packing a rigid shelter according to the present invention for transportation.

### DETAILED DESCRIPTION OF THE EMBODIMENTS

There will now be described by way of example a specific mode contemplated by the inventor(s). In the following description numerous specific details are set forth in order to provide a thorough understanding. It will be apparent however, to one skilled in the art, that the present invention may be practiced without limitation to these specific details. In other instances well known methods and structures are not described in detail, so as not to unnecessarily obscure the description.

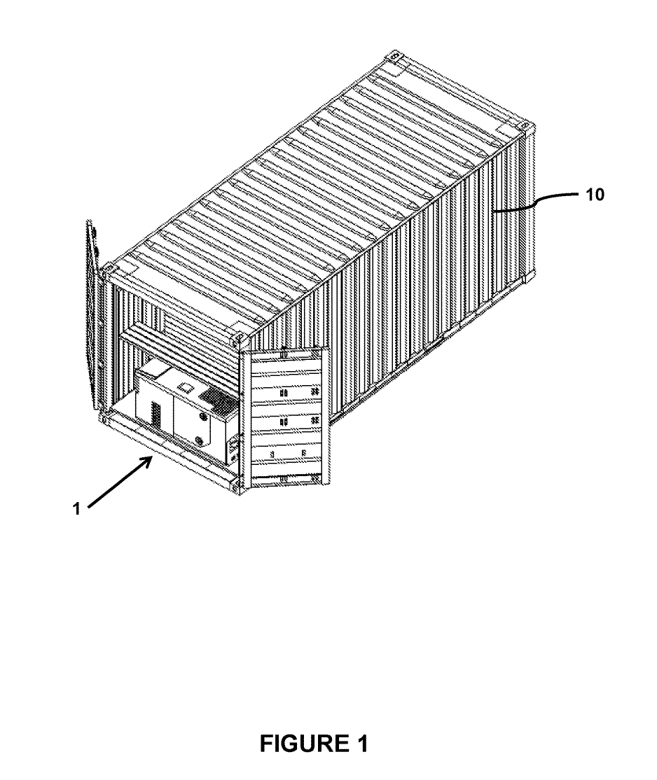

FIG. 1

FIG. 1 is a perspective view of a standard shipping container (10) containing three portable modular apparatus (1) in the disassembled transport condition. Each apparatus (1) comprises a base, a roof, walls, corners, photovoltaic solar collectors, electrical circuit componentry and a utility panel. The base defines a storage compartment. The apparatus (1) are shown here in a disassembled transport condition, but may be assembled into an assembled condition, as will be later shown. In the assembled condition, the base, roof, walls and corners releasably interlock to form a rigid shelter comprising a solar powered electricity supply.

The shipping container (10) shown here is a standard 20 foot by eight foot shipping container (10), containing three apparatus (1) according to the present invention. The apparatus (1) comprises all the components required to provide a rigid shelter comprising a solar powered electricity supply. In this example, a generator (9) is also stored within the container (10). The apparatus (1) is stacked in the disassembled transport condition in such a way as to minimize the volume required. The portable modular shelter apparatus (1) can therefore be easily deployed to the required location by road, rail, seas or air, or by any route or method by which shipping containers such as the one shown here (10) are transported.

In one embodiment the wall element is a wall panel.

The wall panels (4), corner panels or elements (5), roof (3) and base (2) may be fabricated from any suitable material or combination of materials. The inner and outer faces of the wall panels (4), corner panels or elements (5), roof (3) and base (2) may be constructed from different materials. For example, the wall panels (4) may be fabricated from plywood, and provided with a PVC (polyvinyl chloride) coating on an inner face and covered by an aluminium sheet on an outer face. The wall panels (4), corner panels or elements (5), roof (3) and base (2) may comprise insulating material between an inner and an outer face.

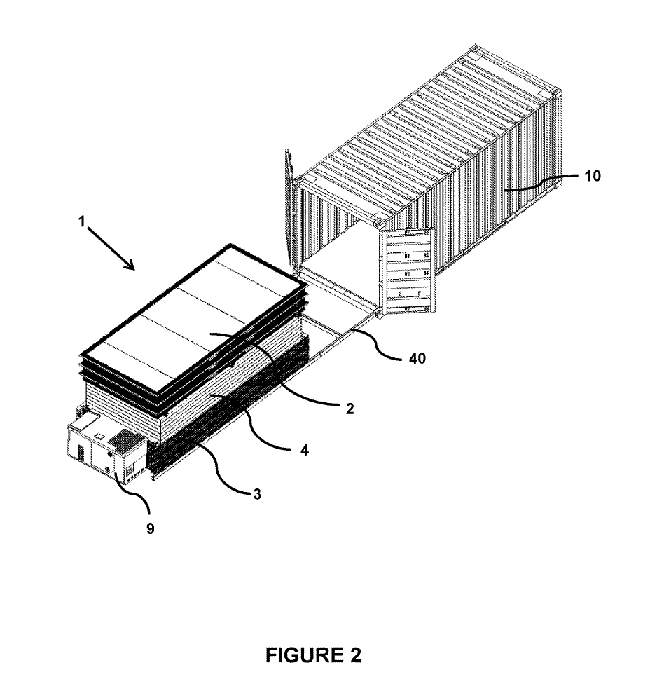

FIG. 2

FIG. 2 is a perspective view of the apparatus (1) of FIG. 1, removed from the shipping container (10). A folding rail (40) may be provided within the container (10) to facilitate deployment of the apparatus (1) from within the container (10). In FIG. 2, the components of three portable modular apparatus (1) are stacked alongside the generator (9). The wall panels (4) of the apparatus (1) are identical in size. At least one of the wall panels (4) from each of the three apparatus (1) will incorporate a door and/or a window (not shown here). A wall panel (4) may incorporate other features, such as hatches or access panels. These doors, windows and other features may be constructed or partially constructed from fiberglass, steel, aluminium, glass, plastics or any other suitable material.

Each wall panel (4) typically weighs 32 kg. This is beneficial where manual handling and assembly of the apparatus is required. In this example, each wall panel (4) is fabricated from fiberglass and aluminium, as are the corner panels or elements, roof and base. Other materials and internal or external finishes may be used, for example, coated steel, plywood, MDF, plasterboard, plastics, laminates. An internal finish may include antibacterial materials, which are beneficial in cases where the rigid shelter (1) is to be used for medical treatment or for educational purposes. Materials used may be fire-resistant or fire-proof.

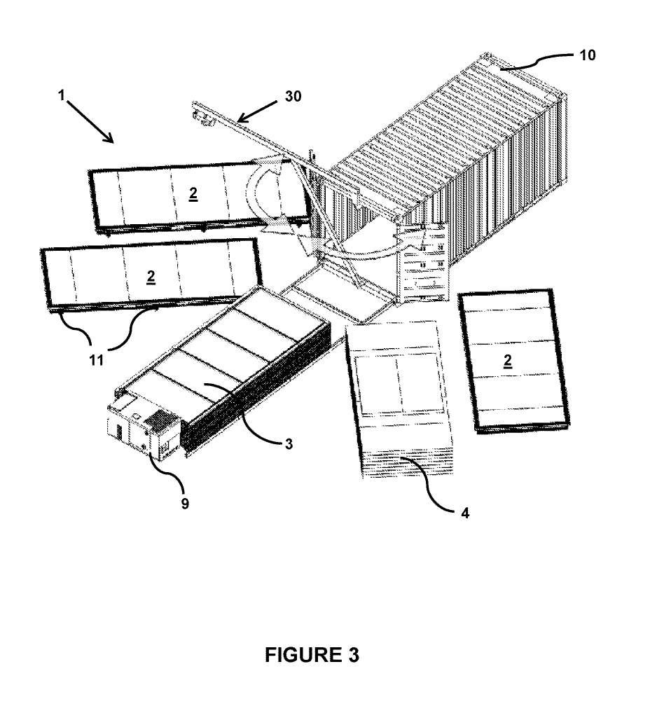

FIG. 3

FIG. 3 is a perspective view of the apparatus (1) of FIG. 1, in which the bases (2) have been moved into position. In this example, a hoist (30) has been supplied as part of the apparatus and has been attached to the shipping container (10) in order to lift the bases (2) from the stack of components and place them into the required position. This hoist (30) is configured to be movable across the open face of the container (10), in the directions of the arrows as shown. However, the apparatus (1) may be moved into the desired position by other means, such as by forklift truck, or manually.

The portable modular shelter apparatus (1) comprises adjustable support devices (11), releasably connected to an underside of the base (2). These support devices (11), or feet, support the base (2) above ground level and are adjustable so as to facilitate the levelling of the base (2), and the rigid shelter (1) as a whole. In this example, each base (2) has at least six such support devices (11), each of which may be adjusted by up to 6″. Each foot (11) may be adjusted in a different plane so as to ensure a level base (2), regardless of the underlying terrain. The feet (11) ensure that the load is evenly spread over the terrain.

In this example, each base (2) is configured to store and house electrical circuit componentry and air conditioning equipment (not shown here). This air conditioning equipment may be used to cool or to heat all or part of the interior volume of an assembled shelter (1). While the apparatus (1) is in the disassembled transport condition, the base (2) may also be used to house components necessary for the assembly of the shelter (1), such as jointing components i.e. components used to join two assembled rigid shelters (1) together.

The base (2) of the rigid shelter (1) in this example comprises an anti-slip coating on an interior surface or floor. Other interior surfaces or coatings may be supplied. The base (1) in this example is rated for loads of up to 62 lb/square foot or 3000 N/m². This load rating may vary depending upon the application.

The electrical circuit componentry required for each rigid shelter (1) is built into each shelter's base (2). This avoids the problem of roof- or wall-mounted electrical circuit componentry falling out of its mounting and becoming damaged, either in transit or during/after assembly of the shelter (1). This serves to reduce costs and to improve safety and the aesthetic appearance of the interior of the shelter (1). Floor-mounted electrical sockets are provided on an interior surface of the base (2), for use with electrical items or equipment, as desired. Electrical sockets for use with lighting or other electrical items may also be provided on an interior face of at least one wall panel (4), and on an interior face of the roof (3). Electrical sockets suitable for the local requirements of different localities may be provided as appropriate.

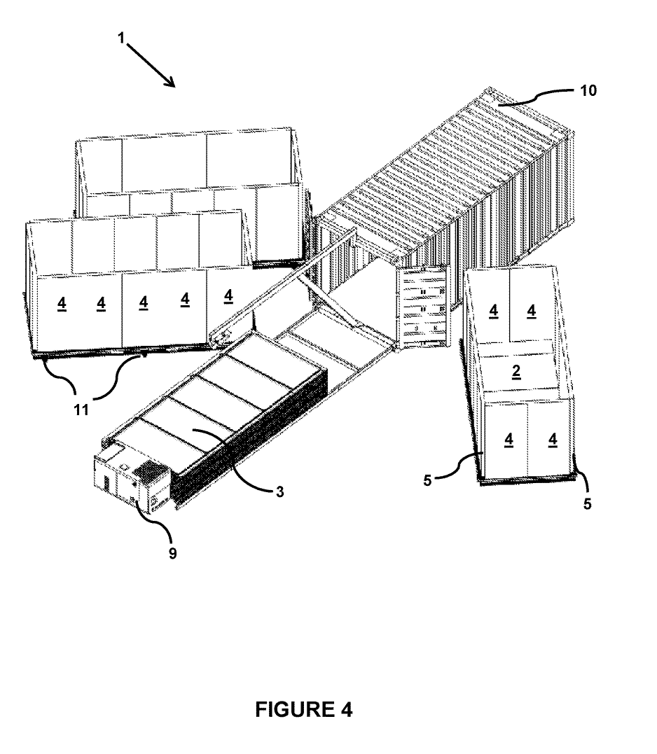

FIG. 4

FIG. 4 is a perspective view of the apparatus (1) of FIG. 1, in which the wall panels (4) and corner panels or elements (5) have been interlocked with the base (2). In this example, each rigid shelter (1) comprises four corner panels or elements (5), each of which extend substantially vertically between the base (2) and the roof (3), when the shelter (1) is assembled. The wall panels (4) connect to form a continuous structure between two corner panels or elements (5). The wall panels (4) additionally extend substantially vertically between the base (2) of the shelter (1) and the roof (3).

In this example, each rigid shelter (1) comprises fourteen wall panels (4), five along each side and two at each end of the shelter (1). Alternative examples, not shown here, may comprise different quantities of wall and corner panels or elements. In this example, each partially-assembled shelter (1) has a substantially rectangular footprint. Each wall panel (4) interlocks releasably with the base (2), via a mechanical connection, such as a cam lock. The wall panels (4) and the base (2) may be securely connected without the requirement for specialist tools or for further fixings, such as nails or screws. A hex or allen key may be used to securely lock the wall panels (4) and base (2) together, forming a continuous structure around the perimeter of the shelter (1). This ensures that the assembled shelter (1) is rigid and stable. The use of only simple tools also simplifies the assembly of the shelter (1), so that it should not be damaged or incorrectly assembled even by personnel with limited or no construction experience. The integral mechanical connection also means that there are fewer parts required.

In this example, the act of securing the wall panels (4) and the base (2) together must be carried out from an interior of the partially-assembled shelter (1). This prevents subsequent unauthorized disassembly of the shelter (1) once assembled, providing a secure building which can be used both for habitation and for equipment storage.

The wall panels (4) include a structural frame cast in during manufacture and each wall panel (4) is typically in the range 80 mm to 100 mm thick. In this example, the wall panels (4) are each 90 mm thick. The wall panels (4), corner panels or elements (5), base (2) and roof (3) each comprise a thermal break to prevent heat transfer between an interior and an exterior of an assembled rigid shelter (1). A thermal break is a plastic section within the aluminium panel which prevents heat transfer between the inside and the outside of the shelter (1). This keeps the shelter (1) warm in cooler climates, and vice versa.

Each wall panel (4), corner panel or element (5), base (2) and roof (3) incorporates insulation. This may take the form of fireproof foam, for example, expanded polyurethane PIR foam. Other forms of insulation may be used. Insulation may be installed within the wall panels, corner panels or elements, roof or base during manufacture or may be manually added during assembly of the apparatus.

In addition to the wall panels (4) shown in this example, the apparatus (1) may include at least one internal partition (not shown here) which may be used to separate the internal volume of the assembled shelter (1) into different areas. This internal partition may be fixed or free-standing, and may be constructed from any suitable material, such as plywood or metal. In this way, one rigid shelter (1) may comprise several different rooms.

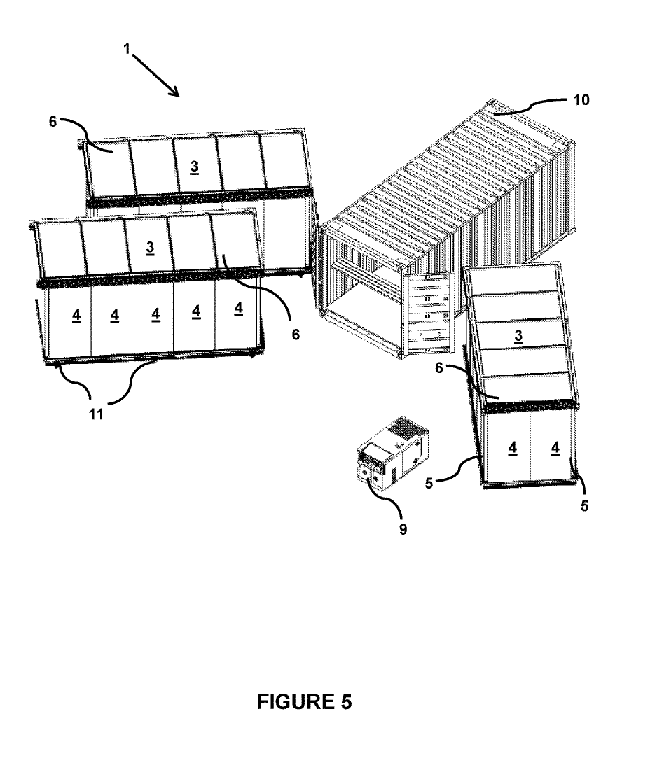

FIG. 5

FIG. 5 is a perspective view of the apparatus (1) of FIG. 1, in the assembled condition. All three apparatus (1) are now in a fully assembled condition, forming three rigid shelters (1). Once assembled, each portable modular shelter apparatus (1) may be configured into a disassembled transport condition again, so that the apparatus (1) may be transported to a second location, or the same location, to be reassembled. Each portable modular shelter apparatus (1) may therefore be used and reused in the same or a different location.

In this example, the exterior faces of each of the roofs (3) comprise photovoltaic material (6). However, such photovoltaic material (6) may be included on an outer surface of one or more of each of the wall panels (4), as well as or instead of on the roof (3). This photovoltaic material (6) may be in the form of panels. Each roof (3) can accommodate a range of sizes of solar panels (6), which may vary in construction and power specification as well as in size. As previously discussed, each rigid shelter (1) comprises a solar powered electricity supply circuit (not shown here). Power is therefore provided to the shelter (1) by the external photovoltaic material (6). The solar powered electricity supply circuit is configured to provide typically in the range 3.8 kWh to 9.0 kWh per day in average light conditions depending on location. This figure may vary depending upon depending upon the available light conditions, and the specification, type, size and number of the photovoltaic panels (6) provided with each rigid shelter (1). More efficient photovoltaic panels may supply up to 20% more electricity.

This allows the shelter (1) to have a supply of electricity in locations where there may be no alternative source of power. This electricity supply may be used to power domestic electrical items, such as kettles or cookers, lighting, heating devices, cooling devices, air conditioning and so forth, as well as other equipment, such as water pumps, or medical or computer/communications equipment. The rigid shelter (1) is therefore capable of being primarily or completely self-powered.

Each roof (3) comprises a permanently-attached plastic trim (not shown here). This acts as a decorative cover and also reduces the possibility of condensation at roof level.

Each roof (3) comprises a single panel and has a welded roof/gutter frame. The roof panel (3) may be constructed from any suitable material, such as fiberglass.

In this example, the roof (3) of the shelter (1) incorporates electrical feed, water management and integrated solar panels yielding typically a 1.7 kWp (kilowatts peak) PV system. More efficient solar panels may have a yield of up to 20% more. The roof (3) is typically rated to a snow depth of 6 feet or to 1000 N/m². The specification and rating of the roof panel (3) may vary between applications.

The roof (3) interlocks with the top of each wall panel (4) in the same way that each wall panel (4) interlocks with the base (2), providing a secure and rigid shelter construction. The act of connecting the roof (3) to each wall panel (4) must be carried out from an interior of the rigid shelter (1). As previously discussed, this prevents unauthorized disassembly of the shelter (1) from the outside and produces a secure shelter (1) suitable for valuable equipment storage as well as habitation.

An interior of the roof panel (3), when in the assembled condition, defines recesses suitable for housing lighting strips (not shown here). These lighting strips may comprise LED lighting, or other suitable forms of low-energy lighting. The lighting strips may be included in and pre-connected to the portable modular shelter apparatus (1).

Housing the lighting within pre-cast recesses in an interior of the roof (3) produces a near-flush internal roof line. This reduces the likelihood of damage to the lighting during transport, assembly or disassembly of the portable modular shelter apparatus (1).

The assembled portable modular shelter (1) in this example further comprises plumbing circuit componentry (not shown here). This componentry may be housed in the base (2), wall panels (4) or in the roof (3). The componentry may be provided in a “plug-and-play” form so as to be readily connectable to the rigid shelter (1). This may be in the form of snap-fit, push-fit, friction-fit, clip or push together or other forms of modular connection. The plumbing componentry may be provided already connected to the apparatus (1) in the disassembled transport condition. The plumbing circuitry may be utilized to provide a water and/or a gas supply and/or waste disposal, for example. The above facilitates quick and easy assembly and disassembly of the portable modular building apparatus (1) and obviates the need for qualified plumbers or gas technicians.

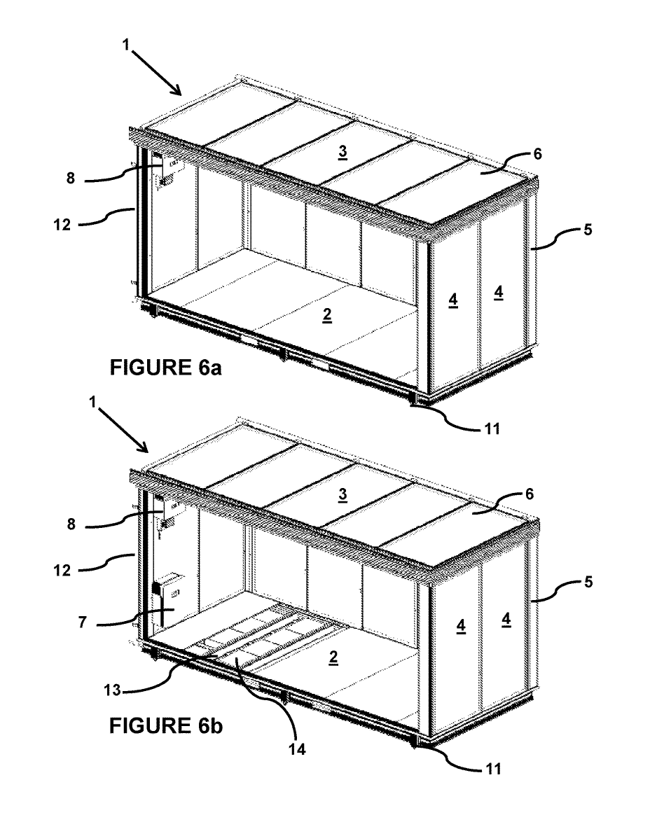

FIG. 6a

FIG. 6a is a perspective view of the apparatus (1) of FIG. 1, the front section cut away to show the interior. FIG. 6a shows an otherwise fully assembled rigid shelter (1) comprising a base (2), a roof (3) with integral photovoltaic material (6), and a plurality of wall panels (4) and corners (5). Each wall panel (4) is interlocked with the roof (3) and the base (2), forming a secure and rigid structure.

Each joint between each of the wall panels (4), corner panels or elements (5), base (2) and roof (3) comprises an integral weather seal (not shown here). An integral weather seal is one which is pre-fitted within the edge of each the panels and does not need to be fitted separately by the personnel assembling the shelter (1). In this example, this weather seal comprises an integral slide-in bubble seal which forms a double seal at each joint, providing resistance to wind, rain, snow and dust. These seals are automatically compressed to the correct form during assembly of the portable modular shelter apparatus (1). The weather seals cannot, therefore, be incorrectly fitted by inexperienced personnel.

In other applications, different types of weather seal may be utilised and the weather rating may vary as a consequence.

The rigid shelter (1) in this example is rated to wind speeds in excess of 120 miles per hour.

The assembled rigid shelter (1) further comprises external drainpipes (12) which connect to the roof (3) and wall panels (4) and which provide an exterior water management solution. These drainpipes (12) may be constructed from plastics, metal, or any suitable material. The drainpipes (12) may be stored within roof gutters when the apparatus is in the transport condition.

The assembled shelter (1) in this example comprises a utility panel (8). In this example the utility panel (8) is housed within a wall panel (4) in an interior of the shelter (1). The utility panel (8) includes an electrical AC consumer unit (not shown) and a solar PV (photovoltaic) inverter (not shown) for DC to AC solar energy conversion. The solar PV (photovoltaic) inverter, or solar inverter, converts the variable direct current (DC) output of the photovoltaic (PV) panels into an alternating current (AC), which can be used by the rigid shelter's (1) electrical circuits. The AC consumer unit is a distribution board which provides electrical power supply to subsidiary circuits. The type and specification of the solar PV inverter and consumer unit may vary by application.

In additional embodiments, not shown here, the utility panel (8) may further comprise at least one of: a power supply type control device, a power input type indicator, a power output type indicator, operating voltage indicator, a power input gauge, a power output gauge, a stored power gauge, an electric plug socket, a switch, a water supply control device, a water input gauge, a water output gauge, a stored water gauge, a gas flow control device, a gas input gauge, a gas output gauge, a diagnostics device, a power supply register device, a power supply termination device, a battery charging device. The utility panel (8) may further comprise any control devices, indictors and any other service (such as water, gas and electricity) management devices as appropriate to a particular application.

The utility panel (8) may supply remote operation, remote monitoring or remote data download capabilities. It may also be configured to control heating, security and communication functions within the shelter (1).

The utility panel (8) may comprise IT or telecommunications equipment, including but not limited to: network switches, routers, wireless access points, patch panels, media converters, network ports, network attached storage, back-up devices.

The utility panel (8) may be configured to supply electricity at different voltages and frequencies, to accommodate different localities. For example, the utility panel (8) may provide 110 Volt/60 Hertz electricity supply, suitable for the USA, or 230 Volt/50 Hertz electricity supply, suitable for the UK and other localities utilizing this type of electrical supply.

The utility panel (8) may be configured to allow a user of the rigid shelter to select which voltage/frequency is supplied, as desired.

The utility panel (8) may be configured to allow both USA and UK electricity supply types, as described above, to be provided simultaneously within the same shelter. This would require the presence of two battery inverters, one for each electricity supply type.

The utility panel (8) may notify a user of the shelter that they have used a pre-defined ration of electricity. This notification may make the shelter's user more aware of their power usage.

FIG. 6b

FIG. 6b is a perspective view of the apparatus (1) of FIG. 1, further comprising a battery power inverter charger (7). A battery power inverter charger (7) is a device which changes direct current (DC) to alternating current (AC) and which can also charge rechargeable batteries. The battery power inverter charger (7) itself does not produce electrical power, the power in this case is supplied as direct (DC) current by an electricity storage device, such as one or more batteries.

In this example, the battery power inverter charger (7) is configured to provide electricity supplied at different voltages and frequencies, to accommodate different localities. For example, the battery power inverter charger may provide 110 Volt/60 Hertz electricity supply, suitable for the USA, or 230 Volt/50 Hertz electricity supply, suitable for the UK and other localities utilizing this type of electrical supply.

The battery power inverter charger (7) may be configured to allow a user of the shelter (1) to select which voltage/frequency is supplied, as desired.

The portable modular shelter apparatus (1) may also comprise an electricity storage device. This may comprise one or more batteries (14), or other forms of electrical storage, depending upon the application.

The base (2) of the rigid shelter (1) defines a storage compartment (13). In this example, this storage compartment (13) is suitable for housing one or more batteries (14), both when the portable modular shelter apparatus (1) is in the disassembled transport condition and when the portable modular shelter apparatus (1) is in the assembled condition and forms a rigid shelter (1).

The advantage of this is that the batteries (14) can be transported within the storage compartment (13) provided in the base (2) of the portable modular shelter apparatus (1). The batteries (14) can be transported in a fully or partially charged condition within the storage compartment (13), and are therefore available to supply power to assist with the assembly of the apparatus (1) as required. This battery power supply can, for example, be used to operate a hoist which may lift the components of the apparatus (1) out of the shipping container (10).

In the case where the batteries included in the portable modular shelter apparatus (1) cannot be transported in a partially or fully charged condition within the storage compartment (13) defined by the base (2), they may be transported separately or within the same shipping container (10) as the apparatus (1).

The batteries (14) stored within the storage compartment (13) of the base (2) are suitable for storing electricity and for supplying electricity to the rigid shelter (1), both during assembly, when in the assembled condition and during disassembly, as required. In this example, this electricity is supplied through a battery power inverter charger (7), as described above. In this example, the storage compartment (13) defined by the base (2) is accessible through a hatch or door within the interior surface of the base (2). This allows access to the batteries (14), for example, for maintenance or replacement purposes.

The batteries (14) in this example are lithium ferrous phosphate rechargeable batteries (also known as LiFePO4 or LFP), but other types of rechargeable and non-rechargeable batteries may be used depending on the application, such as lithium ion batteries, lead-acid batteries, nickel cadmium batteries, nickel metal hydride batteries and so on. In cases where the batteries supplied are unsuitable for storage within the storage compartment (13), the batteries may be stored in a separate structure such as an outbuilding.

The portable modular shelter apparatus (1) may be supplied with batteries (14) as described above, or without batteries. In the latter case, batteries may be supplied separately, or not used at all.

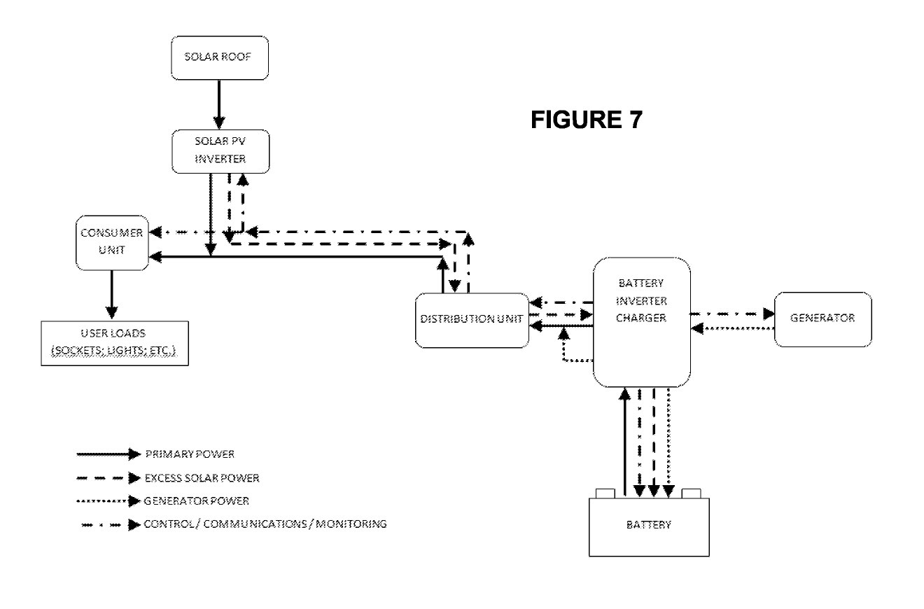

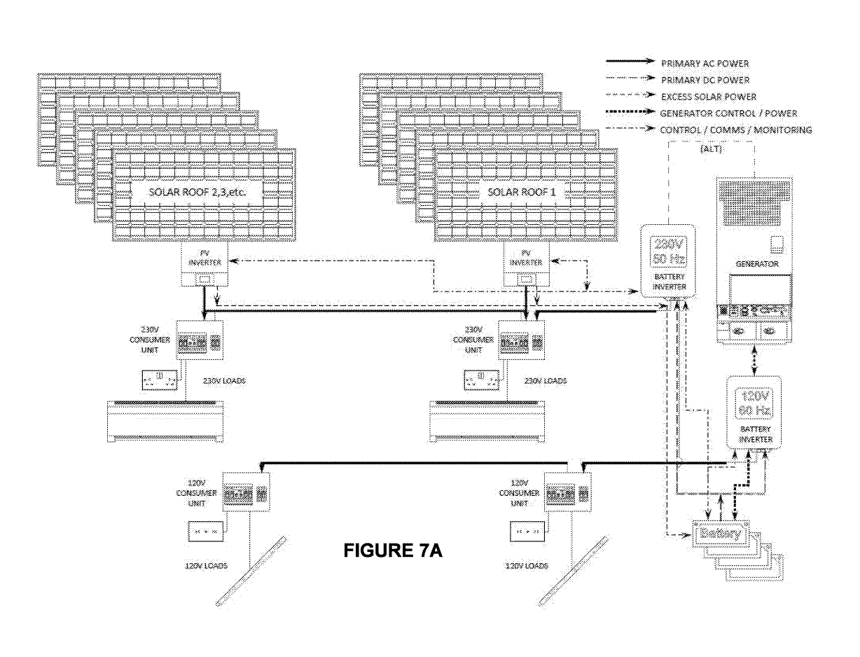

FIGS. 7 and 7A

FIGS. 7 and 7A are schematic diagrams showing the power management system of the present invention.

In this example, the utility panel (8) may be directly or indirectly connected to an engine-generator (9). When so connected, the utility panel (8) may be configurable to initiate or terminate the supply of electricity from the engine-generator (9) in response to detection of a pre-determined condition.

The utility panel (8) may be connected to the above-mentioned engine-generator (9) through the battery power inverter charger (7), which may itself be directly or indirectly connected to the engine-generator (9).

The engine-generator (9), or generator, may be required where insufficient power is generated for the rigid shelter (1) by the photovoltaic panels (6) provided on the roof (3) or wall panels (4) of the shelter (1). This may occur in poor weather conditions or at night. Alternatively, power demand from the shelter (1) may outstrip the capacity of the photovoltaic panels (6), even in fair weather conditions and in daylight. In such cases, the utility panel (8) monitors power demand and supply and activates the generator (9) if the power demand is too high for the photovoltaic panels (6) to meet.

In the case where batteries (14) are supplied with the shelter (1), the utility panel (8) may use power from the batteries (14), via the battery power inverter charger (7), to supplement or replace power provided via the solar PV inverter by the photovoltaic panels (6). The use of batteries in this way reduces or completely eliminates use of external power sources such as generator usage, typically by 75% to 90% or even up to 100%. This reduction in generator usage is advantageous in that it reduces the external power requirements of the shelter (1) and correspondingly reduces the shelter's carbon footprint.

In the case where the power demand from the shelter (1) is too high for the batteries (14) and the photovoltaic panels (6) to meet, the utility panel (8) can temporarily activate the engine-generator (9) to service this demand. Once demand falls again, the utility panel (8) can automatically deactivate the generator (9).

In addition to supplying power, the batteries (14), where supplied, can be recharged using power output from the photovoltaic solar panels (6). The utility panel (8) may monitor the battery charge level, and once the batteries (14) are fully charged, the utility panel (8) may reduce the output of the photovoltaic panels (6) in a controlled fashion.

The utility panel (8) may also monitor the battery charge level and activate the generator (9) in order to charge the rechargeable batteries (14), should it detect a low battery level. This protects the rechargeable batteries (14) from battery damage caused by deep discharge, for example, in cases where the generator (9) runs out of fuel. This also prolongs battery life by managing battery conditioning, for example, equalization cycles.

The utility panel (8) may also periodically check whether the rechargeable batteries (14) require recharging, and then check to see whether solar energy is available from the photovoltaic panels (6) in order to charge the batteries (14). The utility panel (8) can then supply solar power for battery charging.

In the case where the rigid shelter (1) is in a locality provided with a mains power grid, the utility panel (8) may disconnect the batteries (14) and link the photovoltaic panels (6) directly to the local power grid. This acts to extend battery life. During periods where the solar power system of the rigid shelter (1) actually produces solar electricity which is surplus to requirements, the utility panel (8) may feed this excess electricity into the local mains power grid.

In a further example, the utility panel (8) may be directly or indirectly connected to an alternate external energy source, such as a wind turbine. In this way, alternate sources of green energy may be utilised to reduce the carbon footprint of the rigid shelter (1).

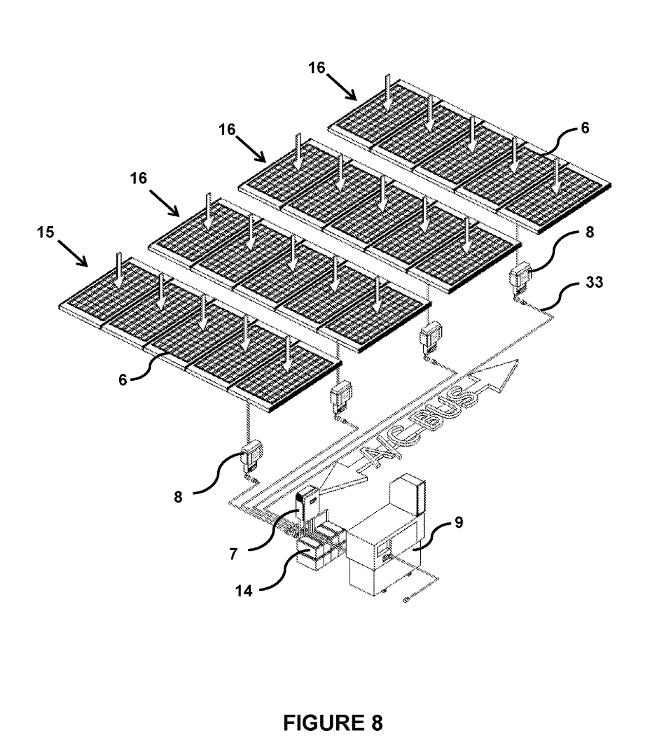

FIG. 8

FIG. 8 is a further schematic diagram showing the power management system of the apparatus (1) according to the present invention. In this example, a rigid shelter (1) may be either a “prime” unit (15), or a “sub” unit (16).

The “prime” unit (15) is provided with rechargeable batteries (14) and a battery power inverter charger (7), as described above. A “sub” unit (16) is not provided with rechargeable batteries (14) and does not have a battery power inverter charger (7). Both types of unit are provided with photovoltaic panels (6) and both have a PV converter. One “prime” unit (15) may power and control several “sub” (16) units, managing the solar electricity produced by the photovoltaic panels (6) on the “sub” units (16) and controlling the source and distribution of electricity for both itself and for the “sub” units (16).

In this example, one rigid shelter is a “prime” unit (15) and the other three rigid shelters are “sub” units (16). This reduces the number of components such as batteries (14) and battery power inverter chargers (7) which are required where more than one portable modular shelter apparatus (15, 16) is deployed. The “prime” unit (15) is also connected to the engine-generator (9).

The electrical connections between each of the “sub” units (16) and the “prime” unit (15) as described above take the form of alternating current (AC) electrical leads (33). Beneficially, these are less bulky than direct current (DC) leads. Electricity generated by the solar panels on each “sub” unit (16) is therefore converted to alternating current (AC) prior to being fed into the “prime” unit (15).

Alternatively the “prime” control system and battery housing can be accommodated in a separate enclosure allowing all units to be “sub” units. This may be beneficial in situations where the units are being used for “quiet” applications and hence the generator and all necessary controls can be located distantly.

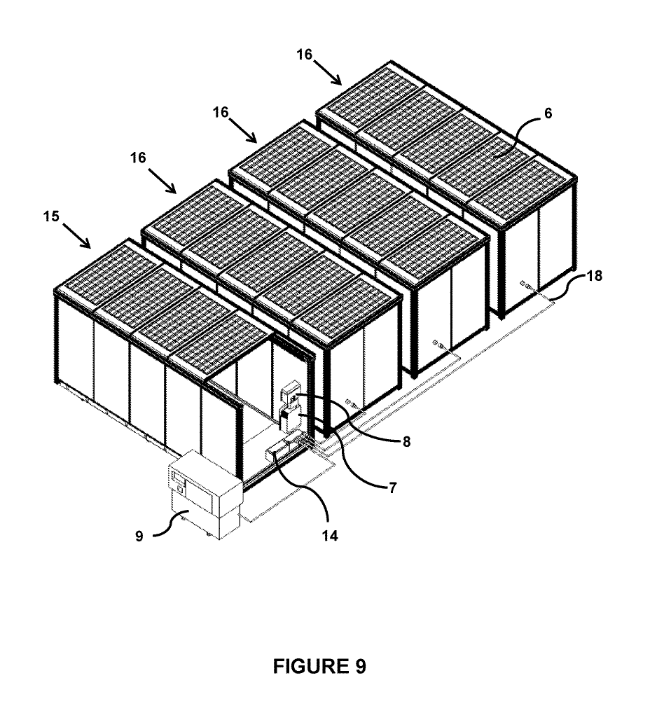

FIG. 9

FIG. 9 is a perspective view of four of the portable modular shelter apparatus (15, 16), linked together to form a plurality of rigid shelters (15, 16). In this example, one rigid shelter is a “prime” unit (15) and the other three rigid shelters are “sub” units (16). The “prime” unit (15) comprises group power management components and all four shelters (15, 16) are connected via electrical cables (18).

Please note that the location of the batteries (14) within the “prime” unit (15) shown in this example is for illustration purposes only.

In a further example, two or more assembled rigid shelters (1, 15, 16) may be connected together to form a plurality of connected rigid shelters (1, 15, 16). A jointing kit (not shown) may be used to connect one shelter (1, 15, 16) with one or more further shelters (1, 15, 16). This jointing kit may be stored in the base (2) of one or more shelters (1, 15, 16) when the apparatus (1, 15, 16) is in the disassembled transport condition.

Where two or more rigid shelters (1, 15, 16) are connected together, a flexible gasket (not shown) may be used where the roofs (3) of the shelters (1, 15, 16) connect. This flexible gasket may be stored in the base (2) of one or more shelters (1, 15, 16) when the apparatus (1, 15, 16) is in the disassembled transport condition.

In a further example, not shown here, the portable modular shelter apparatus (1, 15, 16) may comprise a storey element to provide a rigid shelter (1, 15, 16) with one or more additional storeys. Within one rigid shelter (1, 15, 16), stairs or steps may then be provided into order to access this second storey.

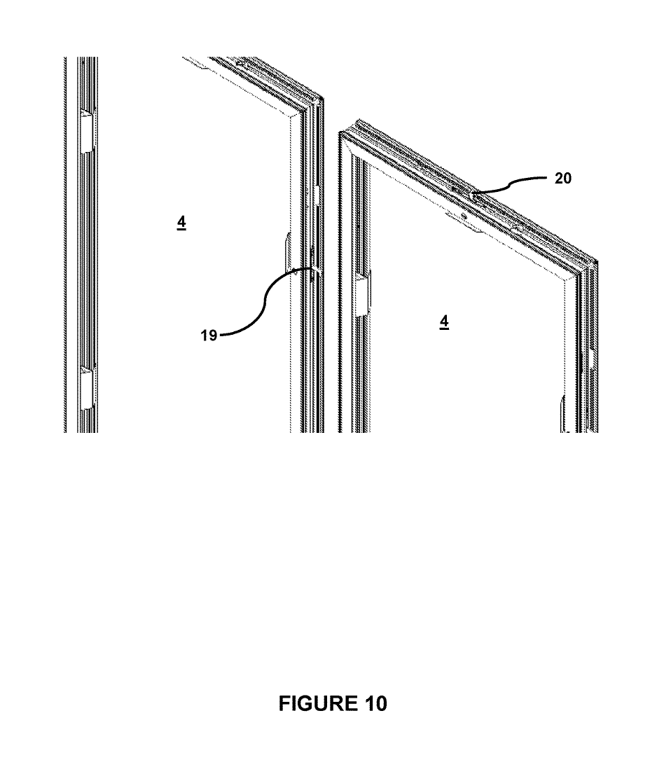

FIG. 10

FIG. 10 is a perspective view of two wall panels (4), according to the present invention. These wall panels (4) are not yet connected to each other. Each wall panel (4) is supplied with a mechanical connection, which in this example is a camlock (19), used to connect each wall panel (4) to either another wall panel (4) or to a corner panel or element (not shown here).

Additionally, each wall panel (4) is provided with a mechanical connection, which in this example is a camlock (20), used to connect each wall panel (4) to the roof (not shown here).

Each wall panel (4) is further provided with a mechanical connection, such as a camlock, to connect the panel to the base (not shown here).

Each camlock (19, 20) has a male and a female component. In this example, only the male component of the camlock is visible. The male component of the camlock (19, 20) is provided on the edge of a first wall panel (4) and locks into the respective female component of the camlock (not shown here), which is provide on the edge of a second wall panel (4), or the base, or a corner panel or element, or the roof.

Each connection between the wall panels (4), corner panels or elements, roof and base can be made using a tool such as a hex key, as previously described. As the connection is made, the camlock (19, 20) pulls the next panel towards the connecting panel and compresses the weatherseal as it does so.

The camlocks (19, 20) shown in this example are stainless steel. Beneficially, these camlocks (19, 20) are hard-wearing and rust resistant. Other materials may be used however, such as plastics, or aluminium.

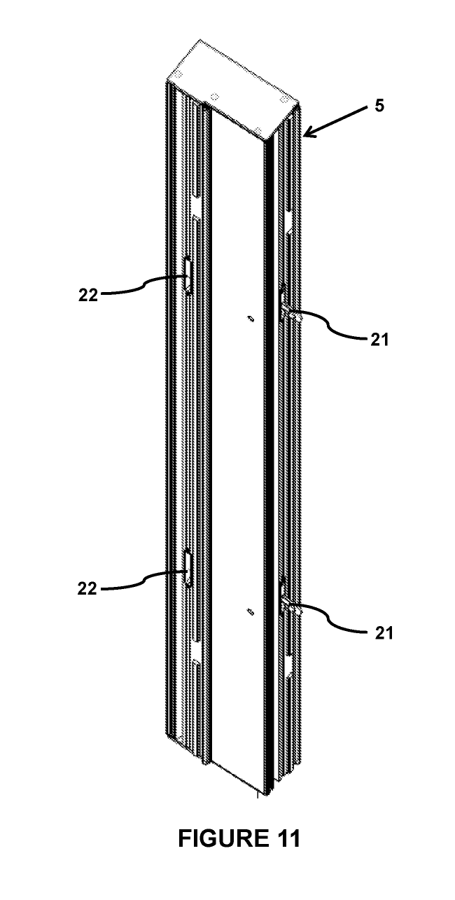

FIG. 11

FIG. 11 is a perspective view of a corner panel or element (5), according to the present invention. The corner panel or element (5) is substantially an L-shape and is used at each corner of the assembled rigid shelter.

The corner panel or element (5) is provided with at least one camlock (21, 22) which enables the corner panel to engage with two wall panels (not shown here). Each camlock (21, 22) has one male component (21) and a female component (22). The male component (21) is configured to engage with a respective female component (not shown here) on the adjacent wall panel. Each female component (22) is configured to engage with a respective male component (not shown here) of an adjacent wall panel.

In this way, the corner panel or element (5) provides a 90 degree turn in the exterior structure of the rigid shelter.

The corner panel or element (5) in this example is of a similar fabrication to the wall panels (not shown here). It is constructed, in this example, from aluminium and fiberglass and is insulated.

In one embodiment the corner panel or element (5) can only be connected to the two adjacent wall panels from an interior of the rigid shelter.

In one embodiment the corner panel or element is a corner post.

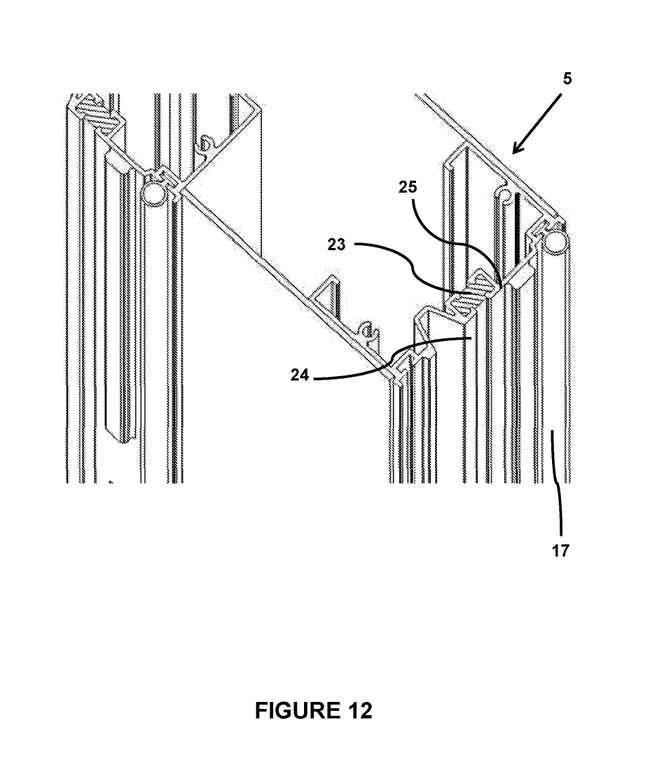

FIG. 12

FIG. 12 is a perspective view of the corner panel or element of FIG. 11. The corner panel or element (5) is provided with at least one thermal break, which reduces heat loss from the interior to the exterior of the rigid shelter in cool climates, and vice versa in hot climates.

In this example, the thermal break is provided by two extruded sections of aluminium (24, 25) which are separated by a plastics material (23). Separation of the aluminium sections (24, 25) in this way ensures no thermal conductivity between them. In further examples, not shown here, the thermal break may be provided by alternative structures and materials.

The corner panel or element (5) shown in this Figure is also provided with an integral weatherseal (17) as previously discussed. A similar weatherseal is provided on each wall panel, roof and base (not shown here).

In this example, the integral weatherseal comprises an integral slide-in bubble seal (17) which forms a double seal at each joint between panels, providing resistance to wind, rain, snow and dust. These seals are automatically compressed to the correct form during assembly of the portable modular shelter apparatus (1). The weather seals (17) cannot, therefore, be incorrectly fitted or omitted by inexperienced construction personnel. The bubble seal (17) in this example comprises closed-cell foam, but other types of weatherseal may be used, which may be fire retardant. Self-adhesive foam tapes, for example, may be used as an alternative weatherseal.

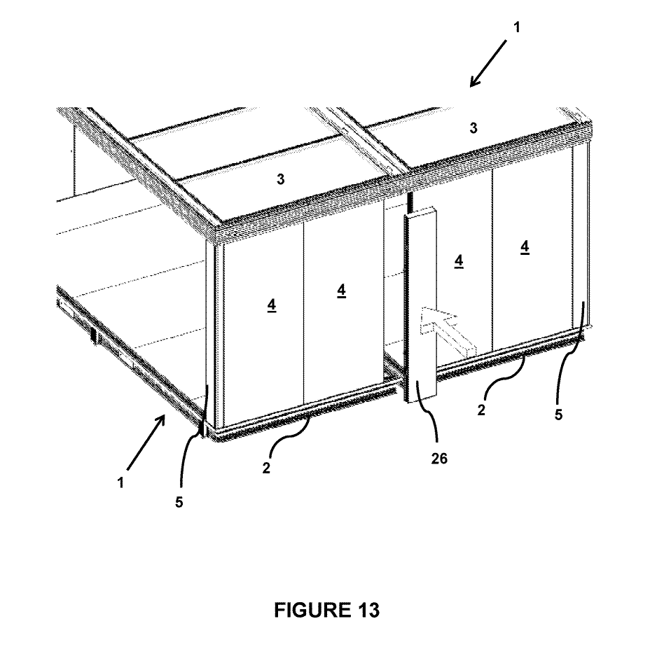

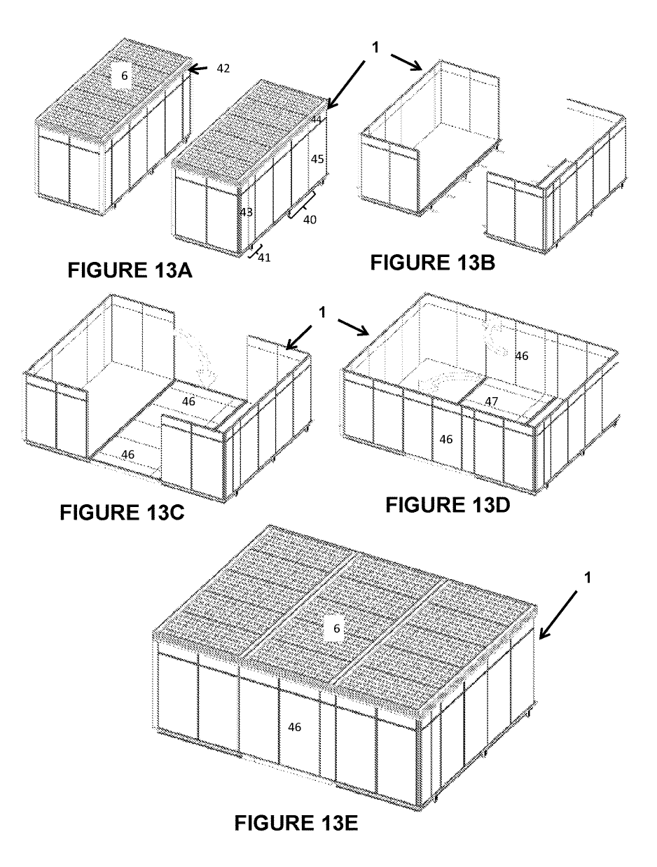

FIG. 13

FIG. 13 is a perspective view of two rigid shelters (1), according to the present invention, close-coupled together.

In this example, a corner panel or element (5) has been omitted on each of the rigid shelters (1) which are to be joined. Instead, a linking panel (26) is used to join the respective end wall panels (4) of the two shelters (1).

The linking panel (26) is of a similar construction to the wall panels (4) and corner panels or elements (5) and comprises at least one thermal break (not shown here) and at least one integral weatherseal (not shown here). The linking panel (26) connects mechanically to the two respective wall panels (4) via at least one camlock, as previously described. This provides a secure and weatherproof connection between the two rigid shelters (1).

Two rigid shelters (1) joined together in this way provide additional secure and weatherproof accommodation or storage space.

FIGS. 13A-E

FIGS. 13A-E are perspective views of the sequence of converting two rigid shelters into three rigid shelters close-coupled together.

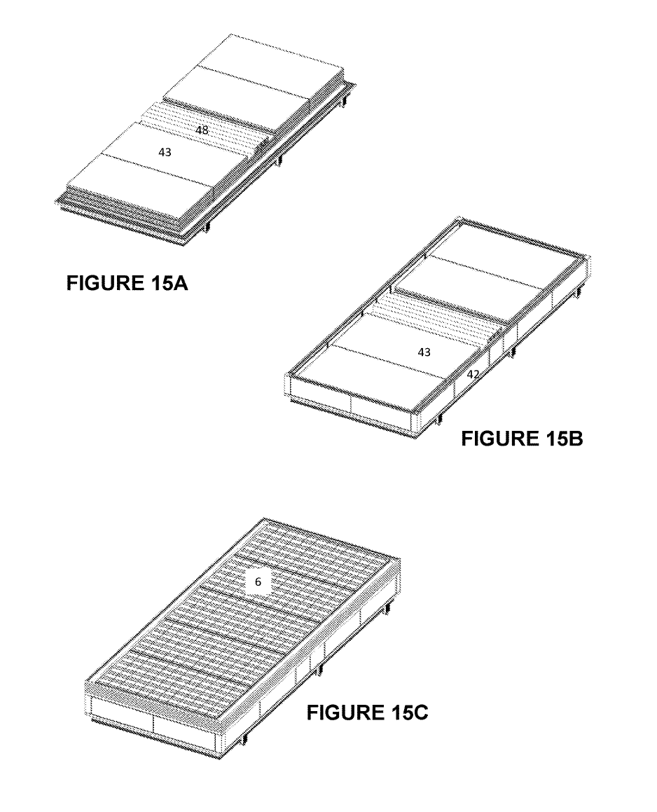

In this example, the longer walls are made up of 4 standard wall panels (40) and 2 bridging panels (41). Both standard and bridging wall panels can be made up of smaller upper panels (42, 44) and larger lower panels (43, 45) which, in normal use, are joined to form a single usable wall panel. Storage features conferred by the upper and lower panel configuration are described in FIGS. 15A-C.

In FIG. 13A is shown two rigid shelters according to the present invention, the orientation of standard panels to bridging panels may be assembled differently in each shelter. In order to convert the two shelters into one larger shelter, one long wall (46, 47) of each of the two shelters is rearranged (as shown in FIG. 13B) such that the wall panels of one shelter divide in two (i.e. 2 standard panels and 1 bridging panel in each half) to form the outer wall to bridge the gap between the two shelters (46). The wall of the other shelter is laid down to form the floor (47) between the two shelters. See FIGS. 13C and D. The new floor (47) may be supported by support devices (11—not shown) built into the base that can be optionally deployed when required or stored when not. Where corner posts are used, these lie on the new floor and perform a locking and weather proofing function.

In one embodiment the corner posts split to enable dismantling for easier storage.

Finally, a canopy roof comprising additional photovoltaic units (6) is provided over the new central area of the larger rigid shelter. Advantageously, two rigid shelters can be converted into the area provided by three rigid shelters by providing just the components required for one canopy roof. This is a considerable benefit since the components for additional walls and floors are not required to be transported. Furthermore, the wall panels that would have previously been removed from the shelter when making a larger area shelter do not need to be stored. Further advantageously, this provides additional power availability to the unit than simply having two rigid shelters. A canopy roof is essentially a standard roof as described herein.

Using the configuration shown in this example, 5 shelters worth of shelter area (i.e. footprint) can be transported in a single container. That is, the area of five individual shelters can be made using the components of just three shelters plus two canopy roofs. All of these components can be transported using just one standard container.

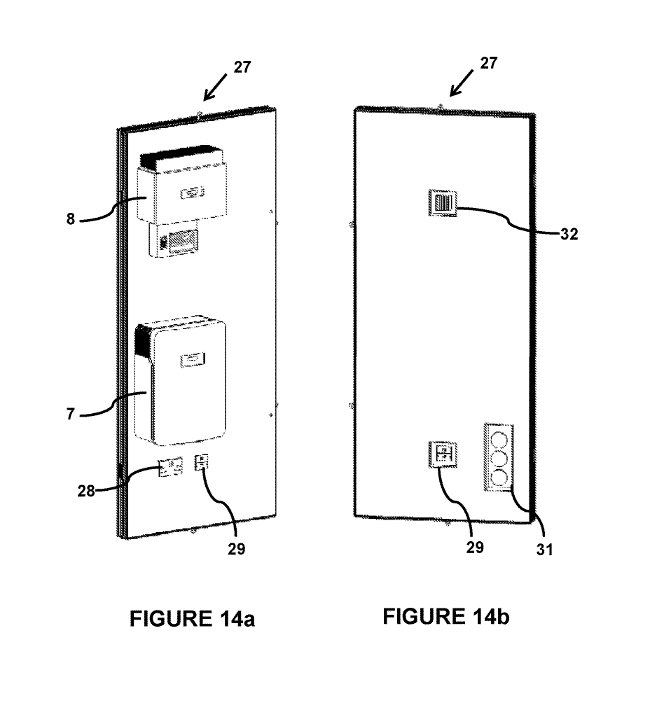

FIGS. 14a and 14b

FIGS. 14a and 14b are perspective views of an exterior and an interior of a wall panel (27) configured to house the utility panel (8), as previously described.

In this example, the utility panel (8) comprises an AC consumer unit and a PV (photovoltaic) converter, as previously discussed. Additionally housed within the wall panel (27) is a battery inverter (7), as previously described. Typically, the components shown in this Figure would form part of a “prime” unit. One “prime” unit may power and control several “sub” units, managing the solar electricity produced by the photovoltaic panels on the “sub” units and controlling the source and distribution of electricity for both itself and for the “sub” units.

Thus while the interior of the wall panel (27) shown in FIG. 14a provides a utility panel (8), a battery power inverter charger (7) and electrical (28) and networking (29) sockets or connections, the exterior of the wall panel (27) as shown in FIG. 14b provides external connections (31) to one or more “sub” units.

The wall panel (27) is typically similar in structure and composition to the other wall panels, as previously discussed. However, this panel (27) is modified to house the utility panel (in the “sub” and “prime” units) and the battery power inverter charger (in the “prime” units only). The panel (27) has internally cast electrical ducting suitable for housing the various cables which may be connected to the utility panel (for example, electrical cables).

The panel (27) also has a sheet of plywood or similar material beneath its inner face, which can be used to attach or retain heavier objects such as the AC consumer unit or solar PV inverter.

Alternatively the “prime” control system and battery housing can be accommodated in a separate enclosure allowing all units to be “sub” units. This reduces the complexity and componentry presence within the structure.

As shown in FIG. 14b, the exterior of the panel (27) defines an aperture (32) through which connections may be made to the utility panel (8) housed in the interior of the panel (27). For example, communication or power cables may be passed through the aperture (32) and connected to or plugged into equipment within the utility panel (8). This aperture (32) is provided with a cover. Typically, the aperture (32) and its cover will present a flush face to the exterior of the wall panel (27) to avoid damage during assembly or transport.

The wall panel (27) may additionally provide a high-level connection box (not shown) for external solar panels, for example those situated on the roof of the shelter.

In further examples, additional external sockets may be provided; in this example a network socket (29) is provided on the exterior face of the wall panel (27). Any exterior sockets, connections, apertures or their covers may present a flush face to the exterior of the wall panel (27) in order to reduce the possibility of damage to them.

The portable modular building apparatus (1, 15, 16) described above may be easily and quickly deployed, using a standard shipping container (10) and conventional means of transport, to any desired location to which a shipping container (10) may be delivered. Once at the desired location, one or more portable modular building apparatus (1, 15, 16) may be quickly and easily assembled, without the requirement for specialist tools or for personnel with construction experience. The majority of components are standardized and so are easy to replace if necessary. However, the apparatus (1, 15, 16) is designed have a simplified construction so that loss of parts, errors or damage during assembly or disassembly is unlikely to occur.

In the case where pre-charged batteries (14) are supplied, the portable modular building apparatus (1, 15, 16) may be used as a power source during its own assembly into a secure, rigid shelter (1, 15, 16), and may subsequently be self-powered through the use of integral photovoltaic panels (6) and rechargeable batteries (14). A power management system provides electricity which is intelligently sourced from a variety of configurable and sustainable sources and which can even feed surplus electricity back into a local power grid. Electricity may be provided according to the technical requirements of the locality to which the shelter (1, 15, 16) has been deployed.

The assembled rigid shelter (1, 15, 16) may be provided with pre-fitted heating, lighting, plumbing components. Additional or optional components, such as an engine-generator (9) or an air-conditioning unit may be stored within the base (2), or within the same shipping container (10). In this way, the assembled rigid shelter (1, 15, 16) provides everything required to support habitation, or to enable the rigid shelter (1, 15, 16) to be used, for example, as a medical treatment centre, communications centre or a school.

FIGS. 15A-C

FIGS. 15A-C show a sequential packing away of the shelter for storage and transportation.

In 15A the larger lower panels (43, 45) are laid flat in rows on the base (2). In a similar way to the panels in use, these lock together in storage. However, they are turned inside out so the locks are accessible from the outside to lock the pack together when the roof is lowered on top as shown in 15C. The corner posts (48) are shown dismantled and stored between the panels.

In 15B the smaller upper panels are disconnected from the lower panels and form a box around the base. The “insides” of the panels face outwards such that the weather tight face of the panels is visible. Advantageously, the orientation of the upper panels permits access to locking devices on the panels, thereby allowing the panels to be locked together and to the roof and base to form a secure box for transportation.

In 15C the roof is stacked on top of the disassembled shelter and locked in place. In this collapsed configuration, if the shelter is stored outside but unassembled, all of the weather-tight features of the assembled unit are replicated so there is no ingress of external elements into the flat-pack. Furthermore, this arrangement forms a very rigid and stable transportation “box” that can withstand rough journeys much better relative to a configuration in which the individual elements that are exposed.

In one embodiment both faces (i.e. the inside and outside) of the wall panels are weather tight.

Disassembled transport condition as used herein means that the components of the apparatus are in a stacked configuration, suitable for transport.

Assembled condition as used herein means that the components of the apparatus have been connected together to produce a rigid shelter.

Rigid shelter as used herein means a building (which may be temporary, semi-permanent or permanent) suitable for human habitation, for storage or for other activities such as a school, a medical treatment centre, a communications hub and so on.

Releasably interlock as used herein means that the components of the apparatus may be connected, disconnected and reconnected from each other.

Mechanical connection as used herein means that the components of the apparatus are joined together via mechanical fixings, such as camlocks or bolts, rather than non-mechanical fixings, such as adhesives.

Jointing components as used herein means components used to join two rigid shelters together.

Thermal break as used herein means an element of low thermal conductivity, such as a plastics material, for example, nylon or poly vinyl chloride, placed in an assembly to reduce or prevent the flow of thermal energy between conductive materials, such as metals. See FIG. 12, number 23.

Photovoltaic material as used herein means a typically semiconducting material which generates electrical power by converting sunlight into direct current electricity.

Integral weatherseal as used herein means a pre-fitted seal which impedes the ingress of rain, snow, hail, sand or dust, constructed from for example closed-cell foam or rubber.

Bubble seal as used herein means a typically elongate cylindrical seal or gasket designed to slide into a recess within a panel frame, to provide weatherproofing and heat transfer, constructed from for example closed-cell foam or rubber.

Adjustable support devices as used herein means feet which support the underside of the base, and which can be rotated, lengthened or shortened to ensure that the assembled shelter is horizontally level even on rough terrain.

Welded roof/gutter frame as used herein means a roof panel comprising an integral gutter which cannot be disassembled from the roof panel.

Storey element as used herein means a second level of shelter stacked above the first level i.e. an additional floor.

In one embodiment stairs or steps are provided to access an additional floor of a rigid shelter.

Outer face as used herein means the face of the panel which is located on the exterior of the shelter, when in the assembled condition.

Electricity storage device as used herein means a physical means of storing electricity for later use, such as thermal energy storage, flywheel energy storage, compressed air energy storage, rechargeable batteries.

Thermal runaway as used herein means a process which is accelerated by increased temperature, in turn releasing energy that further increases temperature, leading to a possible explosion.

Utility panel as used herein means a central storage and distribution point for electrics, communications, plumbing and so forth which may house related equipment and may be accessible to a user in order to perform tasks such as repair, maintenance, monitoring, programming and so on.

Power supply type control device, power input type indicator, power output type indicator, operating voltage indicator, power input gauge, power output gauge, stored power gauge, electric plug socket, switch, water supply control device, water input gauge, water output gauge, stored water gauge, gas flow control device, gas input gauge, gas output gauge, diagnostics device, power supply register device, power supply termination device, battery charging device, solar photovoltaic inverter are terms of the art well-known in the field of energy supply.

In one embodiment the utility panel comprises monitoring or educational equipment, such as an electricity meter.

In one embodiment the utility panel comprises telecommunications equipment.

In one embodiment the utility panel comprises at least one of: a router, a wireless router, a switch, a patch panel, a wireless access point. These are terms of the art in the communications field.

In one embodiment the utility panel is housed within a wall panel.

In one embodiment the utility panel supplies remote operation, remote monitoring or remote data download capabilities.

In one embodiment the utility panel controls heating security and communication functions within the shelter.

In one embodiment the utility panel provides 110 Volt/60 Hertz electricity supply.

In one embodiment the utility panel provides 230 Volt/50 Hertz electricity supply.

In one embodiment the utility panel supplies both USA and UK electricity supply types. In one embodiment this required two battery inverters within the rigid shelter.

In one embodiment the utility panel notifies a user that they have used a pre-defined ration of electricity.

In one embodiment the utility panel can activate and deactivate the engine-generator.

In one embodiment the utility panel monitors the battery charge level.

In one embodiment the utility panel disconnects the batteries.

In one embodiment the utility panel links the photovoltaic panels to the local power grid.

In one embodiment the utility panel feeds excess electricity into the local mains power grid.

In one embodiment a rigid shelter is either a “prime” unit or a “sub” unit.

“Prime” unit as used herein means a rigid shelter provided with rechargeable batteries and at least one battery power inverter, in addition to photovoltaic panels and a PV converter.

“Sub” unit as used herein means a rigid shelter which is not provided with rechargeable batteries and has no battery power inverter. In one embodiment a “sub” unit is provided with photovoltaic panels and a PV converter.

In one embodiment a “prime” unit powers and controls approximately one to five “sub” units, such as approximately 1, 2, 3, 4 or 5 “sub” units, for example, three “sub” units.

In one embodiment electrical connections between the “prime” and “sub” units take the form of alternating current (AC) electrical leads.

In one embodiment electricity generated by the solar panels on each “sub” unit is converted to AC current prior to being fed into the “prime” unit.

In one embodiment three portable modular building apparatus, typically one “prime” unit and two “sub” units, will fit into one standard shipping container.

In one embodiment a jointing kit is used to connect one rigid shelter with one or more further rigid shelters.

In one embodiment a flexible gasket is used where the roofs of two or more rigid shelters connect. This flexible gasket may be stored in the base of a rigid shelter when not in use.

In one embodiment the shelter comprises plumbing circuit componentry.

In one embodiment plumbing circuit componentry is independently housed in or more of the following: the base, the wall panels or the roof.

In one embodiment plumbing circuit componentry is plug-and-play, such as snap-fit, push-fit, friction-fit, clip or push together or other forms of modular connection.

In one embodiment plumbing circuit componentry provides a water and/or gas supply and/or waste disposal.

In one embodiment the apparatus is supplied without plumbing circuitry components and these components may be supplied and installed separately as required.

In one embodiment the adjustable support devices (feet) are flush with the edge of the rigid shelter, allowing two such rigid shelters to be connected together.

In one embodiment each base has at least six such support devices. In one embodiment the support devices may each be adjusted by up to approximately one to ten inches, such as approximately 2, 3, 4, 5, 6, 7, 8 or 9 inches, for example six inches.

In one embodiment external drainpipes are replaced with chains which manage run-off from the root where rainwater is not desired to be harvested.

In one embodiment, the chains are stored within the roof gutters when the apparatus is in the transport condition.

In one embodiment the interior of the storage compartment comprises rails and straps suitable for retaining the batteries in position. This prevents damage to the batteries while the apparatus is in the transport condition.

In one embodiment batteries are stored substantially centrally within the base. This is beneficial when the apparatus is being assembled.

In one embodiment the batteries are stored symmetrically within the base. This is beneficial when the apparatus is being assembled.

In one embodiment the interior of the base comprises cross members and defines a plurality of cavities between these cross members.

In one embodiment the cavities can be used as storage compartments.

In one embodiment insulation in the base is provided by a layer of, for example, aerogel, located in the bottom of the base.

In one embodiment the roof is rated up to approximately 1000 N/m² or a snow depth of approximately 6 feet.

In one embodiment the roof is rated up to approximately 2000 N/m². This ensures that the roof can withstand a substantial volume of snow or sand without damage.

In one embodiment the floor of the rigid shelter is rated up to 110 pounds per square foot. Beneficially, the shelter can be used to store heavy equipment, such as communications or computer equipment.

Floor as employed herein means the top of the base, located within the interior of the rigid shelter.

In one embodiment, each wall panel weighs approximately 20 to 35 kg such as approximately 21, 22, 23, 24, 25, 26, 27, 28, 29, 30, 31, 32, 33 or 34 kg, for example approximately 32 kg.

In one embodiment, each wall panel (including the assembled upper and lower panels) has a height of approximately 2000 to 2400 mm, such as 2000 to 2300 mm such as approximately 2010, 2020, 2030, 2040, 2050, 2060, 2070, 2080, 2090, 2100, 2110, 2120, 2130, 2140, 2150, 2160, 2170, 2180, 2190, 2200, 2210, 2220, 2230, 2240, 2250, 2260, 2270, 2280, 2290, 2300, 2310, 2320, 2330, 2340, 2350, 2360, 2370, 2380 or 2390 for example, approximately 2170 mm or approximately 2300 mm.

In one embodiment, each smaller upper panel, including both standard panels and bridging panels, has a height of approximately 200 to 400 mm, such as approximately 210, 220, 230, 240, 250, 260, 270, 280, 290, 300, 310, 320, 330, 340, 350, 360, 370, 380 or 390 mm, for example approximately 300 mm.

In one embodiment, each larger lower panel, including both standard panels and bridging panels, has a height of approximately 1800 to 2200 mm such as approximately 1810, 1820, 1830, 1840, 1850, 1860, 1870, 1880, 1890, 1900, 1910, 1920, 1930, 1940, 1950, 1960, 1970, 1980, 1990, 2000, 2010, 2020, 2030, 2040, 2050, 2060, 2070, 2080, 2090, 2100, 2110, 2120, 2130, 2140, 2150, 2160, 2170, 2180 or 2190 mm for example approximately 2000 mm.

In one embodiment each standard wall panel, including both upper and lower standard panels, has a width of approximately 800 to 1100 mm, such as approximately 810, 820, 830, 840, 850, 860, 870, 880, 890, 900, 910, 920, 930, 940, 950, 960, 970, 980, 990, 1000, 1010, 1020, 1030 1040, 1050, 1060, 1070, 1080 or 1090 mm, for example, approximately 940 mm or approximately 1000 mm.

In one embodiment each bridging wall panel, including upper and lower bridging panels have a width of approximately 300 to 500 mm, such as 310, 320, 330, 340, 350, 360, 370, 380, 390, 400, 401, 402, 403, 404, 405, 406, 407, 408, 409, 410, 420, 430, 440, 450, 460, 470, 480 or 490 mm for example, approximately 408 mm In one embodiment a wall panel comprises an upper and a lower panel.

In one embodiment a wall panel may be a standard wall panel or a bridging wall panel.

In one embodiment a standard wall panel comprises an upper and a lower standard panel.

In one embodiment a bridging wall panel comprises an upper and a lower bridging panel.

In one embodiment the lower standard panel is approximately 2000 mm high by approximately 1000 mm wide.

In one embodiment the upper standard panel is approximately 300 mm high by approximately 1000 mm wide.

In one embodiment the lower bridging panel is approximately 2000 mm high by approximately 408 mm wide.

In one embodiment the upper bridging panel is approximately 300 mm high by approximately 408 mm wide.

In one embodiment each wall panel, that is, all wall panels including standard and bridging panels, has a depth, that is, a thickness of approximately 50 to 150 mm, such as 60, 70, 80, 90, 100, 110, 120, 130 or 140 mm, for example approximately 90 mm.

In one embodiment each wall panel has the approximate dimension 2170 mm×940 mm×90 mm.

In one embodiment each assembled standard wall panel (comprising upper and lower panels) has the approximate dimension 2300 mm×1000 mm×90 mm.

In one embodiment each assembled bridging wall panel (comprising upper and lower panels) has the approximate dimension 2300 mm×408 mm×90 mm.

In one embodiment each corner panel weighs approximately 8 to 20 kg, such as approximately 9, 10, 11, 12, 13, 14, 15, 16, 17, 18 or 19 kg. For example approximately 13 kg.

In one embodiment the roof weighs approximately 380 to 410 kg (including photovoltaic material), such as approximately 381, 382, 383, 384, 385, 386, 387, 388, 389, 390, 391, 392, 393, 394, 395, 396, 397, 398, 399, 400, 401, 402, 403, 404, 405, 406, 407, 408 or 409 kg. For example, approximately 395 kg.

In one embodiment the base weighs approximately 290 to 315 kg, such as approximately 291, 292, 293, 294, 295, 296, 297, 298, 299, 300, 301, 302, 303, 304, 305, 306, 307, 308, 309, 310, 311, 312, 313 or 314 kg. For example approximately 301 kg.

In one embodiment, each corner panel is substantially L-shaped featuring a long and a short arm. In one embodiment the long arm is approximately 180 to 220 mm, such as approximately 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218 or 219 mm, such as approximately 200 mm. In one embodiment the short arm is approximately 80 to 110 mm such as approximately 81, 82, 83, 84, 85, 86, 87, 88, 89, 90, 91, 92, 93, 94, 95, 96, 97, 98, 99, 100, 101, 102, 103, 104, 105, 106, 107, 108 or 109 mm, for example approximately 94 mm. In one embodiment the L-shape has the approximate dimensions 94 mm×200 mm.

In one embodiment each corner panel provides a 90 degree turn in the exterior structure of the rigid shelter.

In one embodiment the corner element is a corner panel

In one embodiment the corner element is a corner post.

In one embodiment the corner post is a split corner post which can be assembled for use or disassembled for storage.

In one embodiment the corner post is made of metal.

In one embodiment the corner post is weather tight.

In one embodiment the corner post has the approximate dimensions 102 mm×102 mm×2300 mm

In one embodiment each assembled shelter has an external length of approximately 4500 mm to 5500 mm, such as approximately 4550, 4600, 4650, 4700, 4750, 4800, 4850, 4900, 4950, 5000, 5050, 5100, 5150, 5200, 5250, 5300, 5350, 5400, or 5450 mm, for example approximately 5034 mm.

In one embodiment each assembled shelter has an external width of approximately 2000 mm to 2500 mm, such as approximately 2050, 2100, 2150, 2200, 2250, 2300, 2350, 2400, or 2450 mm, for example approximately 2214 mm.

In one embodiment each assembled shelter has an internal length of approximately 4500 mm to 5500 mm, such as approximately 4550, 4600, 4650, 4700, 4750, 4800, 4850, 4900, 4950, 5000, 5050, 5100, 5150, 5200, 5250, 5300, 5350, 5400, or 5450 mm, for example approximately 4814 mm.

In one embodiment each assembled shelter has an internal width of approximately 1800 mm to 2300 mm, such as approximately 1800, 1850, 1900, 1950, 2000, 2050, 2100, 2150, 2200, or 2250 mm, for example approximately 1994 mm.

In one embodiment each assembled rigid shelter has an approximate footprint of 10 to 13 m² such as approximately 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8 or 12.9 m², for example approximately 11.39 m².

In one embodiment each assembled rigid shelter weighs approximately 1290 to 1315 kg, such as approximately 1291, 1292, 1293, 1294, 1295, 1296, 1297, 1298, 1299, 1300, 1301, 1302, 1303, 1304, 1305, 1306, 1307, 1308, 1309, 1310, 1311, 1312, 1313 or 1314 kg, for example, approximately 1306 kg. This weight will vary depending upon the components supplied within the assembled shelter.

In one embodiment the portable modular shelter apparatus comprises an awning.

Advantageously the awning permits people to transition between non-connected shelters whilst remaining undercover. Beneficially this protects them from the elements such as heat and rain and prevents them being visible from above. This is particularly beneficial to military personnel.

In one embodiment the upper surface of the awning comprises photovoltaic material.

Advantageously, this extends the solar capacity of the shelter.

In one embodiment two or more assembled rigid shelters are connected and one or more awnings are used to provide covered walkways between the assembled rigid shelters. These covered walkways provide shade and shelter.

In one embodiment the wall panels, corner panels or elements, roof and base is fabricated from any suitable material.

In one embodiment the wall panels is provided with a PVC (polyvinyl chloride) coating on an inner face.

In one embodiment each wall panel may be provided with an internal finish such as coated steel, plywood, MDF, plasterboard, plastics, laminates, antibacterial materials.

In one embodiment each wall panel, corner panel or element, roof and base is fabricated from fire-resistant or fire-proof materials.

In one embodiment the rigid shelter is used for medical treatment or for educational purposes.

In one embodiment the wall panels, corner panels or elements, roof and base comprise insulating material between an inner and an outer face.

In one embodiment this insulation takes the form of fireproof foam, for example expanded polyurethane PIR foam.

In one embodiment a folding rail is provided within the container.

In one embodiment the wall panels are substantially identical in size.

In one embodiment the wall panels incorporate hatches or access panels.

In one embodiment doors and windows are constructed or partially constructed from fiberglass, steel, aluminium, glass, plastics or any suitable material.

In one embodiment the rigid shelter comprises 12 to 16 wall panels, such as 13, 14 or 15 wall panels, for example 14 wall panels. In one embodiment 14 wall panels are arranged as five along each side and two at each end of the shelter.

In one embodiment the exterior of the wall panel which houses the utility panel defines an aperture through which connections may be made to the utility panel.

In one embodiment this aperture is provided with a cover.

In one embodiment this cover presents a flush face to the exterior of the wall panel.

In one embodiment the wall panel which houses the utility panel provides a high-level connection box for external solar panels.

In one embodiment a hex or allen key is used to securely lock the wall panels and base together.

In one embodiment floor-mounted electrical sockets are provided.

In one embodiment electrical sockets are also be provided on an interior face of at least one wall panel.

In one embodiment a thermal break is a plastic section within the aluminium panel.

In one embodiment the solar powered electricity supply circuit provides typically in the range approximately 3.8 kWh to 9.0 kWh, such as 3.0, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8 or 8.9 kWh.

In one embodiment the solar panels typically yield approximately a 1.7 kWp (kilowatts peak) PV system.

In one embodiment the roof comprises a permanently attached plastic trim.

In one embodiment the roof comprises a single panel

In one embodiment the roof comprises a welded roof/gutter frame.

In one embodiment the roof may be constructed from any suitable material such as fiberglass, plywood, metal, fibreboard.

In one embodiment the roof comprises electrical feed.

In one embodiment the roof comprises water management.

In one embodiment the roof comprises integrated solar panels.

In one embodiment the roof interlocks with the top of each wall panel in the same way that each wall panel interlocks with the base.

In one embodiment the act of interlocking the roof to each wall panel must be carried out from an interior of the rigid shelter.

In one embodiment an interior of the roof panel comprises LED lighting, or other suitable forms of low-energy lighting.

In one embodiment lighting strips are included in and pre-connected to the shelter.

In one embodiment the weather seal comprises or consists an integral bubble seal. In one embodiment the bubble seal is a slide-in bubble seal. In one embodiment the bubble seal forms a double seal at each joint providing resistance to one or more elements independently selected from wind, rain, snow, sand and dust.

In one embodiment different types of weather seal may be utilised such as closed cell foam, latex, memory foam.

In one embodiment the rigid shelter is rated to wind speeds in excess of approximately 120 miles per hour.

In one embodiment the shelter comprises external drainpipes In one embodiment external drainpipes are constructed from plastics, metal or any suitable material.

In the context of this specification “comprising” is to be interpreted as “including”.

Aspects of the disclosure comprising certain elements are also intended to extend to alternative embodiments “consisting” or “consisting essentially” of the relevant elements.

Where technically appropriate, embodiments of the invention may be combined.

Embodiments are described herein as comprising certain features/elements. The disclosure also extends to separate embodiments consisting or consisting essentially of said features/elements.

Technical references such as patents and applications are incorporated herein by reference.

Any embodiments specifically and explicitly recited herein may form the basis of a disclaimer either alone or in combination with one or more further embodiments.

1. Portable modular shelter apparatus, comprising:
a base;
a roof;
a plurality of wall elements;
a plurality of corner elements;
a photovoltaic solar collector;
electrical circuit componentry;
a utility panel;
said base defining a storage compartment therein;
said apparatus configurable from a disassembled transport condition into an assembled condition, in which said base, roof, wall elements and corner elements are configured to releasably interlock to form a rigid shelter comprising a solar powered electricity supply circuit.

2. Portable modular shelter apparatus according to claim 1, wherein the base, roof, wall elements and corner elements interlock mechanically when in said assembled condition.

3. Portable modular shelter apparatus according to claim 1, wherein the base, roof, wall elements and corner elements each further comprise an integral weather seal.

4. Portable modular shelter apparatus according to claim 1, wherein the base, roof, wall elements and corner elements each comprise a thermal break to prevent heat transfer between an interior and an exterior of said rigid shelter.

5. Portable modular shelter apparatus according to claim 1, wherein, when the apparatus is in the assembled condition, an outer face of at least one of the plurality of wall elements or the roof comprises photovoltaic material.

6. Portable modular shelter apparatus according to claim 1, further comprising an electricity storage device.

7. Portable modular shelter apparatus according to claim 1, wherein said storage compartment is suitable for housing batteries, both in said disassembled transport condition and in the assembled condition.

8. Portable modular shelter apparatus according to claim 7, further comprising one or more batteries, said batteries suitable for storing electricity and for supplying electricity to the rigid shelter.

9. Portable modular shelter apparatus according to claim 8, wherein said batteries are rechargeable batteries, such as lithium ferrous phosphate batteries.

10. Portable modular shelter apparatus according to claim 1, wherein the base houses at least one of: electrical circuit componentry; jointing elements; air conditioning.

11. Portable modular shelter apparatus according to claim 1, wherein said utility panel comprises at least one of: a power supply type control device, a power input type indicator, a power output type indicator, operating voltage indicator, a power input gauge, a power output gauge, a stored power gauge, an electric plug socket, a switch, a water supply control device, a water input gauge, a water output gauge, a stored water gauge, a gas flow control device, a gas input gauge, a gas output gauge, a diagnostics device, a power supply register device, a power supply termination device, a battery charging device, a solar photovoltaic inverter.

12. Portable modular shelter apparatus according to claim 1, further comprising a battery power inverter charger.

13. Portable modular shelter apparatus according to claim 1, further comprising a plurality of adjustable support devices, releasably connected to the base.

14. Portable modular shelter apparatus according to claim 1, dimensioned to allow between one and five of said apparatus in the disassembled storage condition to be stored within a standard twenty foot by eight foot shipping container.

15. Portable modular shelter apparatus according to claim 1, wherein said utility panel may be directly or indirectly connected to an engine-generator, and when connected, is configurable to initiate or terminate the supply of electricity from said engine-generator in response to detection of a pre-determined condition.

16. Portable modular shelter apparatus according to claim 1, wherein said utility panel may be directly or indirectly connected to an alternate external energy source, such as a wind turbine or a mains power grid.

17. Portable modular shelter apparatus according to claim 1, wherein said utility panel may be configured to supply electricity at different voltages and frequencies.

18. Portable modular shelter according to claim 1, wherein at least one of the wall elements comprises an upper and a lower wall panel.

19. A method of providing a rigid shelter comprising a solar powered electricity supply circuit, comprising the steps of:
a) receiving a portable modular shelter apparatus in a disassembled transport condition, the portable modular shelter apparatus having a base, a roof, a plurality of wall elements, a plurality of corner elements, a photovoltaic solar collector, electrical circuit componentry and a utility panel, said base defining a storage compartment therein;
b) configuring said portable modular shelter apparatus into an assembled condition providing a rigid shelter comprising a solar powered electricity supply circuit, wherein said base, said roof, said plurality of wall elements and said plurality of corner elements are releasably interlocked.

20. (canceled)

21. (canceled)
